(19) United States
(12) Patent Application Publication
(10) Pub. No.: US 2026/0016816 A1
(43) Pub. Date: Jan. 15, 2026

(54) METHOD AND MACHINE ASSEMBLY FOR SEPARATING PLATE-TYPE WORKPIECES

(71) Applicant: TRUMPF Werkzeugmaschinen SE + Co. KG, Ditzingen (DE)

(72) Inventors: Stefan Krause, Wilthen (DE); Konrad Gnauck, Neukirch (DE); Marcus Busch, Dresden (DE); Patrick Wowtscherk, Neschwitz (DE)

(21) Appl. No.: 19/333,423

(22) Filed: Sep. 19, 2025

Related U.S. Application Data
(63) Continuation of application No. PCT/EP2023/057485, filed on Mar. 23, 2023.

(51) Int. Cl. G05B 19/418; B23K 26/03; B23K 37/04

(52) U.S. Cl. CPC G05B 19/41875; B23K 26/032; B23K 37/04; G05B 19/4183

(57) ABSTRACT

A method for monitoring a condition of a processed product produced from a plate-type starting workpiece including sheet metal, by separating the starting workpiece, as part of a continuous manufacturing process. An actual state of a parameter of the condition of the processed product is detected. The method includes detecting the condition of the processed product before separation of the starting workpiece. The actual state of the at least one parameter of the condition of the starting workpiece is detected on the starting workpiece before the separation thereof. A product-forming region of the starting workpiece which forms the processed product after the separation of the starting workpiece is assigned the actual state of the at least one parameter of the condition of the starting workpiece detected for the product-forming region as the actual state of the at least one parameter of the condition of the processed product.

### CROSS REFERENCE TO RELATED APPLICATIONS

This application is a continuation of International Application No. PCT/EP2023/057485 (WO 2024/193826 A1), filed on Mar. 23, 2023. The aforementioned application is hereby incorporated by reference herein.

### FIELD

The invention relates to a method for monitoring the condition of a processed product produced from a starting workpiece, a method for controlling a continuous manufacturing process, to a manufacturing process, a machine assembly for the separation of plate-type workpieces, and to a computer program for operating a machine assembly.

### BACKGROUND

Prior art is disclosed in DE 10 2020 123 555 A1.

The prior art relates to a method and a device for automated quality control on cutting systems for the separation of fabric material strips. In a processing unit of the previously known device, fabric material parts are produced by separating a fabric material strip. After their creation, the fabric material pieces are moved along a camera, which detects the condition of the fabric material pieces. A control unit of the device checks whether the detected condition of the fabric material parts correspond to the relevant specifications. If defective fabric material parts are identified, the control unit modifies selected parameters of the processing unit in order to eliminate the cause of the error and enable the subsequent production of defect-free fabric material parts.

### SUMMARY

In an embodiment, the present disclosure provides a method for monitoring a condition of a processed product produced from a plate-type starting workpiece comprising sheet metal, by separating the starting workpiece, as part of a continuous manufacturing process. An actual state of at least one parameter of the condition of the processed product is detected in the course of the manufacturing process. The method comprises detecting the condition of the processed product in a course of the manufacturing process before separation of the starting workpiece. The actual state of the at least one parameter of the condition of the starting workpiece is detected on the starting workpiece before the separation thereof. A product-forming region of the starting workpiece which forms the processed product after the separation of the starting workpiece is assigned the actual state of the at least one parameter of the condition of the starting workpiece detected for the product-forming region as the actual state of the at least one parameter of the condition of the processed product.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a machine assembly for separating sheet metal from a coil; and

FIG. 2 shows a machine assembly for the separation of sheet metal panels.

### DETAILED DESCRIPTION

In an embodiment, the present disclosure provides for avoiding the production of defective processed products as far as possible during the separation of workpieces, in particular sheet metal.

Embodiments of the present disclosure relate to methods for monitoring the condition of sheet metal by separating the plate-type starting workpiece as part of a continuous manufacturing process, wherein an actual state of at least one parameter of the condition of the processed product is detected in the course of the manufacturing process. Embodiments also relate to methods for controlling a continuous manufacturing process and to a manufacturing process, wherein, as part of this method and process, the condition of a processed product produced by separating a starting workpiece is monitored according to the aforementioned monitoring method. Embodiments also relate to machine assemblies for the separation of sheet metal having a separating device, by means of which a processed product can be produced from an starting workpiece by separating the starting workpiece, and a monitoring device which is designed to detect the condition of the processed product, in that the monitoring device has a detection device by means of which an actual state of at least one parameter of the condition of the processed product can be detected on the processed product. Embodiments also relate to computer programs for operating machine assemblies of the aforementioned type.

In an embodiment of the present disclosure, the condition of a processed product produced by separating a starting workpiece is already detected in advance of the production of the processed product on the basis of that region of the starting workpiece which forms the processed product after the separation. The actual state of at least one parameter of the condition of the starting workpiece is detected on the starting workpiece in a location-related manner. This means that it is known in which region of the starting workpiece the parameter of the condition of the starting workpiece has which actual state. For the detection of the actual state of a parameter of the condition of the starting workpiece prior to the separation, the machine assembly according to the present disclosure has a detection device arranged upstream of the separating device.

At the same time, it is already known in advance of the separation of the starting workpiece, for example due to a nesting of the starting workpiece with processed products stored for the starting workpiece in a numerical control of the machine assembly according to the present disclosure, which region of the starting workpiece will form the processed product after its separation. By means of an evaluation device, the actual state of the parameter of the condition of the starting workpiece identified for this region is assigned to the product-forming region of the starting workpiece as the actual state of the condition of the processed product.

The monitoring concept according to the present disclosure makes it possible to gain knowledge about the condition of the processed products at an early stage of a continuous manufacturing process and, if necessary, to intervene in the manufacturing process in a controlling manner.

The computer program according to the present disclosure controls the machine assembly according to the present disclosure for carrying out the manufacturing process according to the present disclosure and, for this purpose, comprises corresponding control commands for a numerical arrangement control.

In an embodiment of a method according to the present disclosure, an actual state of at least one parameter of the condition of the processed product is detected even after the separation of the starting workpiece. The detection takes place on the processed product. A machine assembly provided for implementing this embodiment of the method according to the present disclosure comprises a monitoring device with a detection device arranged downstream of the separating device.

In an embodiment of a method according to the present disclosure, the actual state of at least one parameter of the condition of the processed product, which remains unchanged during the further manufacturing process, is detected on the starting workpiece and/or on the processed product. In this case, a one-time detection of the actual state of the condition parameter(s) is sufficient. The actual state of the parameter of the condition of the starting workpiece detected on the starting workpiece readily reflects the actual state of the condition of the processed product.

In an embodiment of the present disclosure, the thickness and/or the surface condition and/or the flatness and/or the separating edge condition and/or the dimensional accuracy of the processed product are monitored as condition parameters that are particularly relevant for the quality of a processed product produced by separating a starting workpiece.

In order to control the machine assembly according to the present disclosure, in an embodiment of the present disclosure, the actual state of the parameter in question of the condition of the processed product, which is detected before and/or after the separation of the starting workpiece, is compared with an assigned target state. The manufacturing process according to the present disclosure and/or the machine assembly according to the present disclosure are controlled depending on the comparison result.

In an embodiment, the machine assembly according to the present disclosure has a numerical arrangement control.

When controlling the machine assembly according to the present disclosure, the general conditions of the monitored continuous manufacturing process can also be taken into account.

Information about the general conditions of the continuous manufacturing process is optionally stored in a preferably programmable data memory of the numerical arrangement control of the machine assembly according to the present disclosure. For example, it is conceivable that, even before the separation of the starting workpiece, it is determined within the scope of the present disclosure monitoring of the condition of the product-forming region of the starting workpiece that, due to the determined condition of the starting workpiece, the processed products cannot be produced with the desired quality using the continuous process. If, at the same time, information stored in the data memory of the numerical arrangement control indicates that the condition of the starting workpiece, which is unsuitable for the current process, meets the quality requirements of a manufacturing process that is planned after the current manufacturing process, the current manufacturing process can be aborted by means of the numerical arrangement control and the subsequently planned manufacturing process can be brought forward.

In an embodiment of the present disclosure, the data memory for the general conditions of the continuous manufacturing process is part of an ERP (enterprise resource planning) system.

The separating device of the machine assembly and/or a feeding device arranged on a feed side of the separating device, by means of which the starting workpiece can be fed to the separating device and/or an unloading device arranged on a discharge side of the separating device, by means of which the processed product can be discharged from the separating device, are particularly suitable as functional units of the machine assembly according to the present disclosure, which are controlled depending on the condition of the processed product monitored before and/or after the separation of the starting workpiece.

A particularly practical application of the present present disclosure is the separating of sheet metal from a coil. When separating sheet metal from a coil, the output of processed products is extremely high. Against this background, it is particularly important to detect the quality of the manufactured products as early as possible and, if necessary, to influence a continuous manufacturing process as early as possible.

Embodiments of the present disclosure will be explained in more detail below on the basis of exemplary schematic illustrations.

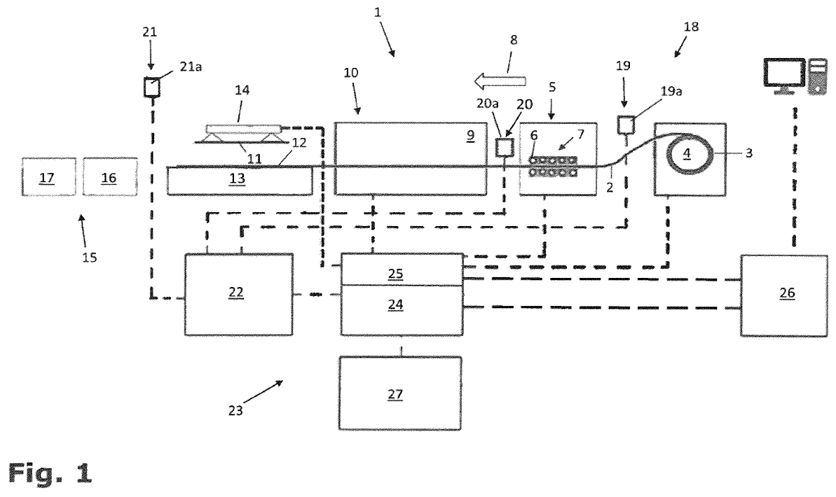

According to FIG. 1, a machine assembly 1 is used to process sheet metal 2 which is wound onto a reel 4 in the form of a coil 3. Adjacent to the reel 4 there is a straightening device 5 of conventional design with straightening rollers 6.

The straightening rollers 6 are provided in the usual manner with a controllable motor drive and are part of a feeding device 7, by means of which the sheet metal 2 is unwound from the coil 3 in sections and moved in a feed direction 8 into a working space 9 of a laser cutting machine 10 provided as a separating device.

The highly schematically illustrated laser cutting machine 10 in the example shown is a conventional laser flatbed machine. The sheet metal 2 is fed section by section by means of the feeding device 7 to a workpiece support of the laser cutting machine as a starting workpiece to be separated. During the separation, a laser cutting head of the laser cutting machine 10 is moved in a known manner with a two-axis horizontal working movement over the section of the sheet metal 2 resting on the workpiece support of the laser cutting machine 10.

In the present case, a sheet metal workpiece 11 and also a residual grid 12 enclosing the sheet metal workpiece 11 are produced from the sheet metal 2 as a processed product.

After the separation is complete, the sheet metal 2 is moved further in the feed direction 8. As a result, the processed section of the sheet metal 2 is transferred to an unloading table 13 arranged downstream of the laser cutting machine 10 in the feed direction 8. At the same time, a still unprocessed section of the sheet metal 2 is moved into its processing position on the workpiece support of the laser cutting machine 10 as a new starting workpiece.

At the unloading table 13, the sheet metal workpiece 11 is picked up by a conventional suction frame 14 serving as an unloading device and is brought by means of the suction frame 14 to a storage location 15 at which a first workpiece storage area 16 and a second workpiece storage area 17 are provided. The residual grid 12 initially remaining on the unloading table 13 is divided by means of a device and then also removed from the unloading table 13.

Just like the feeding device 7 and the laser cutting machine 10, the suction frame 14 also forms a functional unit of the machine assembly 1.

The condition of the sheet metal workpieces 11 produced on the machine assembly 1 is continuously monitored during the continuous separating manufacturing process. For this purpose, a monitoring device 18 is provided with a first detection device 19, a second detection device 20 and a third detection device 21.

A sheet thickness gauge 19a as a detector of the first detection device 19 is arranged between the reel 4 and the straightening device 5. The second detection device 20 has a camera 20a as a detector between the straightening device 5 and the laser cutting machine 10. A further camera 21a is provided as a detector of the third detection device 21 near the unloading table 13.

The first detection device 19, the second detection device 20 and the third detection device 21 have a common numerical detection unit 22. The sheet thickness gauge 19a as well as the camera 20a and the camera 21a are connected to said unit. The numerical detection unit 22 is part of a numerical arrangement control 23 of the machine assembly 1.

In the exemplary case shown, the thickness of the sheet 2 unwound from the coil 3 is determined by means of the first detection device 19. In the example shown, the second detection device 20 is used to determine the surface condition of the sheet metal 2 after leaving the straightening device 5, and the third detection device 21 is used to determine the condition of the separating edges of the sheet metal workpiece 11 transferred to the unloading table 13 after leaving the working space 9 of the laser cutting machine 10. Due to the arrangement of the sheet thickness gauge 19a and the cameras 20a, 21a, the first detection device 19 and the second detection device 20 are arranged upstream of the laser cutting machine 10 and the third detection device 21 is arranged downstream of the laser cutting machine 10.

The actual states of the thickness and surface condition of the sheet metal 2 detected by the first detection device 19 and the second detection device 20 as well as the separating edge condition of the sheet metal workpiece 11 detected by the third detection device 21 are evaluated in an evaluation unit 24 of the numerical arrangement control 23.

In a continuous manufacturing process, the sheet metal 2 unwound from the coil 3 is moved intermittently by means of the feeding device 7 in the feed direction 8 over partial feed lengths which are matched to the extension of the workpiece support in the feed direction 8 and the range of the laser cutting head in the working space 9 of the laser cutting machine 10. The movement of the partial feed lengths of the sheet metal 2 in the feed direction 8 is defined with the help of a path measuring system of the feeding device 7. Consequently, it is ensured that a partial feed length of the sheet 2 detected by the sheet thickness measuring device 19a with regard to its thickness and/or a partial feed length of the sheet 2 detected by the camera 20a with regard to its surface condition reaches a defined processing position in the working space 9 of the laser cutting machine 10 during its movement in the feed direction 8. At the same time, the assignment of the sheet metal workpiece 11 for a feed partial length of the unprocessed sheet 2 is stored in the evaluation unit 24 of the numerical arrangement control 23 of the machine assembly 1. Consequently, in the evaluation unit 24, the region of a partial feed length of the unprocessed sheet metal 2 (starting workpiece) can be identified on the unprocessed sheet metal 2, which was scanned in sections before the separation by means of the sheet metal thickness measuring device 19a and the camera 20a, which will form the sheet metal workpiece 11 (processed product) as the product-forming region of the starter workpiece after the separation by means of the laser cutting machine 10.

The evaluation device 24 assigns the actual state of the thickness of the still unprocessed partial length of the sheet metal 2, detected by means of the first detection device 19, as the actual state of the thickness of the sheet metal workpiece 11, and the actual state of the surface condition of the still unprocessed partial length of the sheet metal 2, detected by means of the second detection device 20, as the actual state of the surface condition of the sheet metal workpiece 11, to the product-forming region of the still unprocessed partial length of the sheet metal 2. This assignment is readily possible because the actual states detected by the first detection device 19 and the second detection device 20 remain unchanged in the course of the further manufacturing process.

By means of the third detection device 21, the separating edge condition of the sheet metal workpiece 11 arranged on the unloading table 13 is detected directly on the sheet metal workpiece 11 after the separation of the sheet metal.

In the evaluation unit 24 the actual states of the thickness, the surface condition and the separating edge condition of the sheet metal workpiece 11 are compared with the target states of these three parameters of the condition of the sheet metal workpiece 11 stored in the evaluation unit 24. Depending on the result of the comparison of the actual state with the target state, the feeding device 7, the laser cutting machine 10 and the suction frame 14 are controlled by a control unit 25 of the numerical arrangement control 23 with corresponding control commands.

If a deviation of the actual state from the target state is detected during the comparison of the actual state with the target state of the monitored parameters of the condition of the sheet metal workpiece 11 carried out in the evaluation unit 24, the control unit 25 generates control commands for the relevant functional unit of the machine assembly 1, which adapts the detected actual state to the relevant target state.

If, for example, it is determined by means of the first detection device 19 that the thickness of the product-forming region of the unprocessed sheet metal 2 deviates from the thickness of the sheet metal workpiece 11 specified for the continuous manufacturing process, the control unit 25 can stop the feeding device 7 by means of a corresponding control command and thereby ensure that the separation of the sheet metal 2 is aborted immediately after the sheet metal feed is started and, consequently, the manufacture of sheet metal workpieces 11 of inferior quality is avoided from the outset.

In the exemplary case shown, it is also possible for the numerical arrangement control 23 to take into account the general conditions of the continuous manufacturing process when controlling the machine assembly 1. Such general conditions are stored in a programmable data memory 26 of the numerical arrangement control 23. The data memory 26 is part of an ERP (enterprise resource planning) system.

In the present exemplary case, the data memory 26 contains, among other things, information about a manufacturing process that is to be carried out by means of the machine assembly 1 following the continuous manufacturing process and that differs from the continuous manufacturing process only in the requirements for the surface quality of the manufactured sheet metal workpieces 11.

If the evaluation unit 24 determines that the surface condition of the sheet metal workpiece 11 detected by the second detection device 20 does not meet the quality requirements for the current manufacturing process, but does meet the quality requirements for the subsequently planned manufacturing process, the current manufacturing process can be aborted by means of the control unit 25 and the manufacturing process intended at a later time can be brought forward. In a corresponding manner, the numerical arrangement control 23 can control the machine assembly 1 in cases in which the thickness of the sheet metal workpiece 11 detected by means of the first detection device 19 does not correspond to the current requirements, but does correspond to the requirements in the case of a subsequently planned manufacturing process.

The knowledge about the actual state of the cutting edge condition of the sheet metal workpiece 11 obtained by means of the third detection device 21 is taken into account by the numerical arrangement control 23 when controlling the suction frame 14. If it is determined by means of the third detection device 21 that the separating edge condition of the sheet metal workpiece 11 corresponds to the specifications for the continuous manufacturing process, the control unit 25 controls the suction frame 14 in such a way that the suction frame 14 transfers the sheet metal workpiece 11 to the first workpiece storage area 16 at the storage location 15. If the separating edge condition of the sheet metal workpiece 11 detected by the third detection device 21 does not meet the specified quality requirements, the suction frame 14 is controlled by the control unit 25 in such a way that the suction frame 14 transports the sheet metal workpiece 11 to the second workpiece storage area 17. The second workpiece storage area 17 is intended for sheet metal workpieces 11 whose separating edges require reworking.

In the exemplary case shown, the information obtained during the monitoring and control of the machine assembly 1 as part of the continuous manufacturing process is transmitted to a data integration platform 27, which can be accessed during future manufacturing processes.

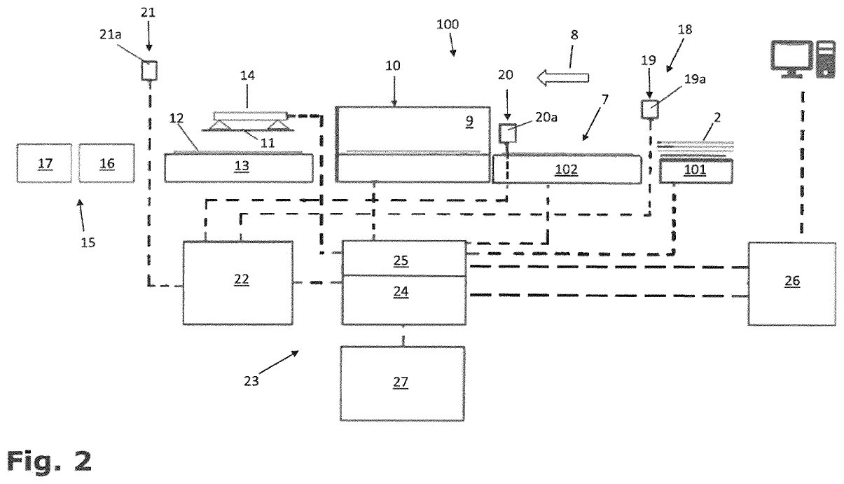

A machine assembly 100, as shown in FIG. 2, differs from the machine assembly 1 according to FIG. 1 in that the sheet metal 2 to be separated is not in the form of a coil but rather as a sheet metal panel. During processing, the sheet metal panel is stored on a conventional workpiece pallet in the working area 9 of the laser cutting machine.

The feeding device 7 of the machine assembly 100 accordingly does not comprise a straightening device according to FIG. 1 but rather a loading device 101 and a pallet changer 102. The loading device 101 and the pallet changer 102 are of conventional design and are shown only in a highly schematic manner in FIG. 2. By means of the loading device 101, the pallet changer 102 is loaded with metal sheets 2 to be processed. A metal sheet 2 to be placed on the pallet changer 102 is taken up by the loading device 101 from a stack of metal sheets.

As with the laser cutting machine 10 and the suction frame 14 of the machine assembly 100, the loading device 101 and the pallet changer 102 are also controlled by means of a numerical arrangement control 23. The monitoring and control of the machine assembly 100 for carrying out manufacturing processes for separating sheet metal is carried out in the same manner as in the case of the machine assembly 1 according to FIG. 1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a condition of a processed product produced from a plate-type starting workpiece comprising sheet metal, by separating the starting workpiece, as part of a continuous manufacturing process, wherein an actual state of at least one parameter of the condition of the processed product is detected in the course of the manufacturing process, the method comprising:
detecting the condition of the processed product in a course of the manufacturing process before separation of the starting workpiece,
wherein the actual state of the at least one parameter of the condition of the starting workpiece is detected on the starting workpiece before the separation thereof, and
wherein a product-forming region of the starting workpiece which forms the processed product after the separation of the starting workpiece is assigned the actual state of the at least one parameter of the condition of the starting workpiece detected for the product-forming region as the actual state of the at least one parameter of the condition of the processed product.

2. The monitoring method according to claim 1, wherein the actual state of the at least one parameter of the condition of the processed product is detected on the processed product in the course of the manufacturing process after the separation of the starting workpiece.

3. The monitoring method according to claim 1, wherein the actual state of the at least one parameter of the condition of the processed product which remains unchanged during a further manufacturing process is detected on the starting workpiece and/or on the processed product.

4. The monitoring method according to claim 1, wherein:
an actual state of a thickness and/or an actual state of a surface condition and/or an actual state of a flatness of the processed product is/are detected on the starting workpiece as the actual state of the at least one parameter of the condition of the processed product, and/or
the actual state of the thickness and/or the actual state of the surface condition and/or the actual state of the flatness and/or an actual state of a separating edge condition and/or an actual state of dimensions of the processed product is/are detected on the processed product as the actual state of the at least one parameter of the condition of the processed product.

5. A method for controlling a continuous manufacturing process, in the course of which a processed product is produced from a plate-type starting workpiece comprising sheet metal by separating the plate-type starting workpiece, the method comprising:
monitoring a condition of the processed product during the continuous manufacturing process, and
controlling the continuous manufacturing process depending on the condition of the processed product,
wherein the monitoring method according to claim 1 is carried out to monitor the condition of the processed product.

6. The control method according to claim 5, wherein the continuous manufacturing process is controlled depending on the condition of the processed product, by:
comparing the detected actual state of the at least one parameter of the condition of the processed product with an assigned target state, and
controlling the continuous manufacturing process depending on a result of the comparison of the detected actual state with the assigned target state.

7. The control method according to claim 5, wherein the continuous manufacturing process is controlled depending on the condition of the processed product and also depending on general conditions of the continuous manufacturing process.

8. A manufacturing process in which a processed product is produced from a plate-type starting workpiece comprising sheet metal by separating the plate-type starting workpiece,
wherein the condition of the processed product is monitored during the continuous manufacturing process,
wherein the continuous manufacturing process is controlled depending on the condition of the processed product, and
wherein the control method according to claim 5 is carried out to control the continuous manufacturing process.

9. A machine assembly for separating plate-type workpieces comprising sheet metal, the machine assembly comprising:
a separating device, by which a processed product is configured to be produced from a starting workpiece by separating the starting workpiece; and
a monitoring device configured to detect a condition of the processed product, the monitoring device having a detection device by which an actual state of at least one parameter of the condition of the processed product can be detected on the processed product,
wherein the monitoring device is configured to detect the condition of the processed product in a course of the manufacturing process before the separation of the starting workpiece,
wherein the monitoring device has the detection device arranged upstream of the separating device, by which the actual state of the at least one parameter of the condition of the starting workpiece is configured to be detected on the starting workpiece before the separation thereof, and
wherein an evaluation device is provided, by which the actual state of the at least one parameter of the condition of the starting workpiece detected for a region can be assigned to a product-forming region of the starting workpiece, which forms the processed product after the separation of the starting workpiece, as the actual state of the at least one parameter of the condition of the processed product.

10. The machine assembly according to claim 9, wherein the monitoring device is configured to detect the condition of the processed product in the course of the manufacturing process after the separation of the starting workpiece, and wherein the monitoring device has a further detection device arranged downstream of the separating device, by which the actual state of the at least one parameter of the condition of the processed product is configured to be detected on the processed product.

11. The machine assembly according to claim 9, wherein:
the upstream detection device of the monitoring device is configured to detect an actual state of a thickness of the starting workpiece and/or to detect an actual state of a surface condition of the starting workpiece and/or to detect an actual state of a flatness of the starting workpiece and/or
the downstream further detection device of the monitoring device is configured to detect an actual state of a thickness of the processed product and/or to detect an actual state of a surface condition of the processed product and/or to detect an actual state of a flatness of the processed product and/or to detect an actual state of a separating edge condition of the processed product and/or to detect an actual state of dimensions of the processed product.

12. The machine assembly according to claim 9, wherein the machine assembly has a numerical arrangement control which controls at least one controllable functional unit of the machine,
wherein the numerical arrangement control has a detection unit, an evaluation unit, and a control unit,
wherein the detection unit of the numerical arrangement control forms part of the upstream detection device and is connected to a detector of the upstream detection device,
wherein information about the actual state of the at least one parameter of the condition of the starting workpiece is configured to be transmitted to the detection unit from the detector of the upstream detection device,
wherein the evaluation unit of the numerical arrangement control is provided as an evaluation device and is connected to the detection unit,
wherein, by the evaluation unit, the actual state of the at least one parameter of the condition of the starting workpiece detected for the region can be assigned to the product-forming region of the starting workpiece which forms the processed product after the separation of the starting workpiece as the actual state of the at least one parameter of the condition of the processed product and
a comparison of the actual state of the at least one parameter of the condition of the processed product detected on the starting workpiece with an assigned target state is configured to be carried out,
wherein the control unit of the numerical arrangement control is connected to the evaluation unit and to the controllable functional unit of the machine assembly and
wherein the controllable functional unit is configured to be controlled by the control unit based on a result of the comparison of the detected actual state of the at least one parameter of the condition of the processed product with the assigned target state to adapt the detected actual state of the parameter of the condition of the processed product to the assigned target state.

13. The machine assembly according to claim 10, wherein:
the detection unit of the numerical arrangement control forms part of the downstream further detection device and is connected to a detector of the downstream further detection device,
information about the actual state of the at least one parameter of the condition of the processed product can be transmitted to the detection unit from the detector of the downstream further detection device,
a comparison of the actual state of the at least one parameter of the condition of the processed product detected on the processed product with an assigned target state is configured to be carried out by the evaluation unit, and
the controllable functional unit is configured to be controlled by the control unit based on a result of the comparison of the actual state of the at least one parameter of the condition of the processed product detected on the processed product with the assigned target state, if necessary to adapt the actual state of the parameter of the condition of the processed product detected on the processed product to the assigned target state.

14. The machine assembly according to claim 12, wherein:
the control unit of the numerical arrangement control is connected to the evaluation unit and to a data memory in which information about general conditions of the continuous manufacturing process carried out by the machine assembly is stored, and
the controllable functional unit of the machine assembly is configured to be controlled by the control unit depending on the general conditions of the continuous manufacturing process.

15. The machine assembly according to claim 14, wherein the data memory for the general conditions of the continuous manufacturing process is part of an enterprise resource planning (ERP) system.

16. The machine assembly according to claim 12, wherein the following is provided as a controllable functional unit of the machine assembly:
the separating device and/or
a feeding device arranged on a feed side of the separating device and by which the starting workpiece is configured to be fed to the separating device, and/or
an unloading device arranged on a discharge side of the separating device and by which the processed product is configured to be discharged from the separating device.

17. The machine assembly according to claim 9, wherein the machine assembly is configured for processing sheet metal from a coil.

18. A non-transitory computer-readable medium having processor-executable instructions stored thereon, wherein the processor-executable instructions, when executed by one or more processors, facilitate performance of the manufacturing process according to claim 8.
